(19) United States
(12) Patent Application Publication
(10) Pub. No.: US 2010/0313109 A1
(43) Pub. Date: Dec. 9, 2010

(54) SYSTEM AND METHOD FOR GENERATING A PERIODIC REPORT

(75) Inventor: YING-CHUAN TSAI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/650,809

(22) Filed: Dec. 31, 2009

(30) Foreign Application Priority Data
Jun. 4, 2009 (CN) 200910302918.0

(51) Int. Cl. G06F 17/00; G06F 17/30

(52) U.S. Cl. 715/212; 707/740; 707/E17.046

(57) ABSTRACT

A system and method for generating a periodic report provides a current file and a historic file. The historic file stores information of periodic reports having been generated. The current file stores information for generating the periodic report. Data of each of the columns are classified into a plurality of types. Totals of the classified data of each type are computed. The periodic report is generated after a spreadsheet program is executed according to the information of the historic file and the totals of the classified data.

BACKGROUND

1. Technical Field

Embodiments of the present disclosure relate to report generation, and more particularly to a system and method for generating a periodic report.

2. Description of Related Art

A spreadsheet program may be used to generate reports to represent work states of different departments. If a user wants to generate a periodic report, the user needs input historic data. Furthermore, items of the periodic report are the same, the input is repeated. Such manual operations may waste a lot of time.

What is needed, therefore, is an improved system and method for generating a periodic report.

### BRIEF DESCRIPTION OF THE DRAWINGS

FIG. 1 is a block diagram of one embodiment of a computer comprising a report generating system.

FIG. 2 is a block diagram of one embodiment of functional modules of the report generating system in FIG. 1.

FIG. 3 is a flowchart of one embodiment of a method for generating a periodic report.

FIG. 4 is a schematic diagram illustrating one embodiment of a current file.

FIG. 5 is a schematic diagram illustrating one embodiment of a periodic report generated.

### DETAILED DESCRIPTION

All of the processes described below may be embodied in, and fully automated via, functional modules executed by one or more general purpose processors. The functional modules may be stored in any type of computer-readable medium or other computer storage device. Some or all of the methods may alternatively be embodied in specialized computer hardware or communication apparatus.

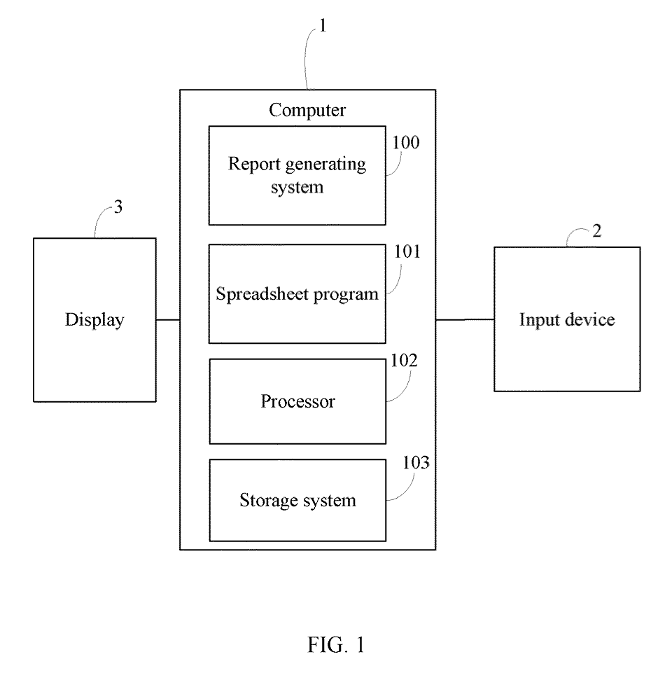

FIG. 1 is a block diagram of one embodiment of a computer 1 comprising a report generating system 100. The report generating system 100 may be used to generate a periodic report. The computer 1 includes a spreadsheet program 101, which may include various software vendors, such as MICROSOFT EXCEL. The computer 1 is connected to an input device 2 and a display 3. In one embodiment, the input device 2 may be a mouse and/or a keyboard.

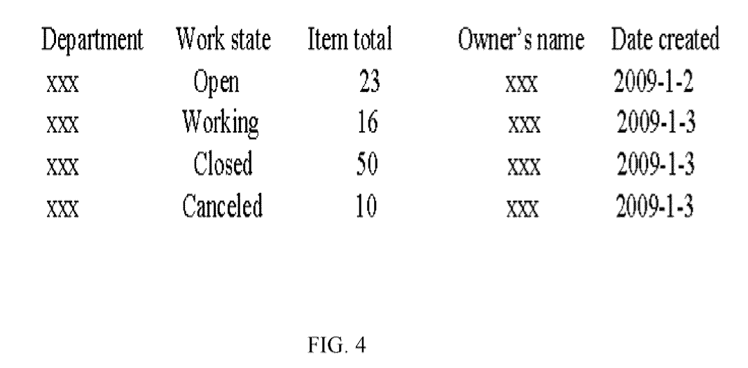

The computer 1 includes a processor 102 and a storage system 103. The processor 102 executes one or more computerized operations of the computer 1 and other applications, to provide the functions of the computer 1. The storage system 103 stores one or more programs, such as programs of an operating system, other applications of the computer 1, and various kinds of data, such as personalized function settings and original function settings of the computer 1, historic reports, or E-mails, for example. The storage system 103 stores a current file and a historic file. The current file includes information of generating the periodic report. The current file may be a text file. The historic file may be a text file and may include historic information regarding previous data. In one embodiment, a periodic report may be generated to relate to a work schedule of a particular person or persons. The current file may be a spreadsheet that comprises work schedules of one or more people divided into various columns. As shown in FIG. 4, the columns may include a department column, a work state column, an item total column, an owner's name column, and a date created column, for example. The historic file may store the periodic reports. In one embodiment, the period may be preset according to actual requirements, such as a week or a month.

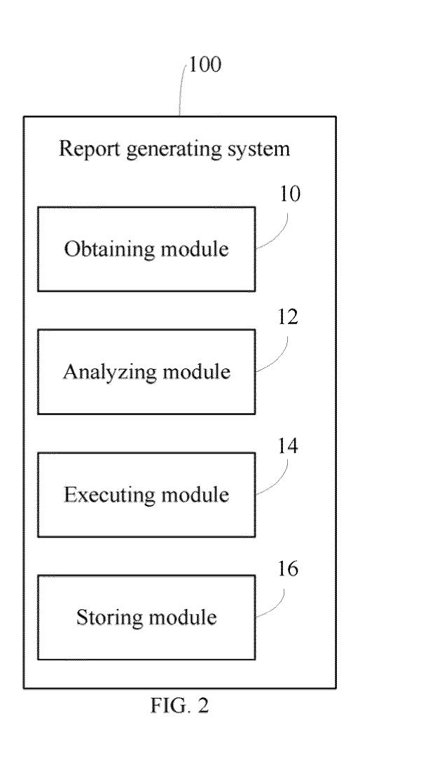

FIG. 2 is a block diagram of functional modules of the report generating system 100 in FIG. 1. In one embodiment, the report generating system 100 may include an obtaining module 10, an analyzing module 12, an executing module 14, and a storing module 16. It may be understood that the processor 102 may be used to execute one or more computerized codes of the functional modules 10, 12, 14, and 16. The one or more computerized codes of the functional modules 10, 12, 14, and 16 may be stored in the storage system 103.

The obtaining module 10 obtains data in the columns from the current file to generate the periodic report. In one embodiment, as shown in FIG. 4, the obtaining module 10 obtains data in the work state column and the item total column to generate a periodic report of work schedule. The obtaining module 10 also reads data from a historic file of the storage system 103. In one embodiment, the obtaining module 10 reads the work states and the item totals of each week.

The analyzing module 12 classifies data in the columns into a plurality of types according to the periodic report to be generated, and computes a total of the classified data of each type. As shown in FIG. 4, the work state column includes an open state, a working state, a closed state, and a canceled state. The classified data are classified into the open state type, the working state type, the closed state type, or the canceled state type. The analyzing module 12 computes the total of the classified data of each type. For example, the total of the classified data of the open state type is 32, and the total of the classified data of the working state is 16.

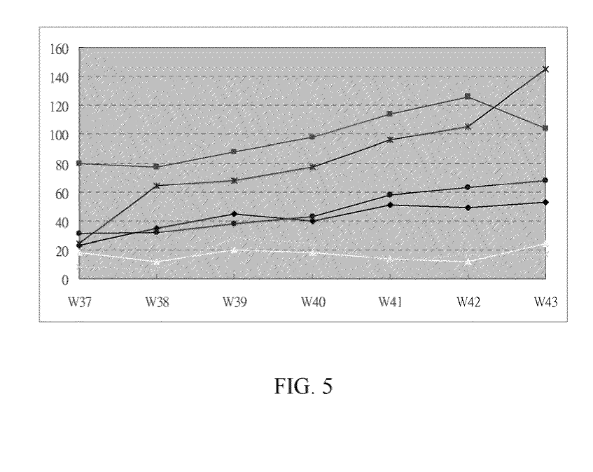

The executing module 14 sets parameters of the periodic report to be generated. In one embodiment, the parameters may include a color of a frame of the periodic report, sizes of frame lines, and colors of curves in the periodic report, for example. The executing module 14 also generates the periodic report by executing the spreadsheet program 101 according to the historic data, the classified column data, and the set parameters. As shown in FIG. 5, the periodic report is generated in a chart form. The periodic report represents work states of each week.

The storing module 16 stores report data and the set parameters of the periodic report into the historic file.

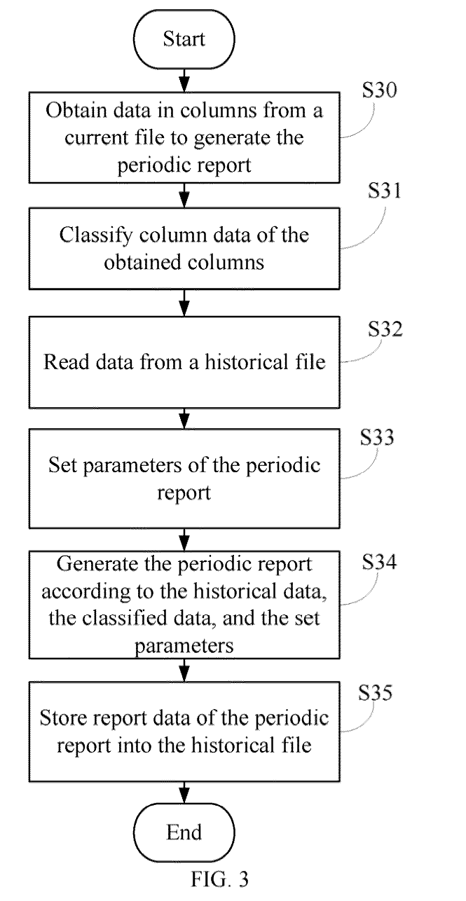

FIG. 3 is a flowchart of one embodiment of a method for generating a periodic report. Depending on the embodiment, additional blocks may be added, others removed, and the ordering of the blocks may be changed.

In block S30, obtaining module 10 obtains data in columns from the current file to generate the periodic report. In one embodiment, as shown in FIG. 4, the obtaining module 10 obtains data in the work state column and the item total column to generate a periodic report of work schedule.

In block S31, The analyzing module 12 classifies data in the columns into a plurality of types according to the periodic report to be generated, and computes a total of the classified data of each type. As shown in FIG. 4, the work state column includes an open state, a working state, a closed state, and a canceled state. The classified data are classified into the open state type, the working state type, the closed state type, or the canceled state type. The analyzing module 12 computes the total of the classified data of each type. For example, the total of the classified data of the open state type is 32 and the total of the classified data of the working state is 16.

In block S32, the obtaining module 10 also reads data from a historic file in the storage system 103. In one embodiment, the obtaining module 10 reads the work states and the item totals of each week.

In block S33, The executing module 14 sets parameters of the periodic report to be generated.

In block S34, the executing module 14 generates the periodic report by executing the spreadsheet program 101 according to the historic data, the classified column data, and the set parameters. As shown in FIG. 5, the periodic report is generated in a chart form. The periodic report represents work states of each week.

In block S35, the storing module 16 stores report data and the set parameters of the periodic report into the historic file.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system, comprising:
a storage system; and
at least one processor to execute one or more programs stored in the storage system, the one or more programs comprising:
an obtaining module operable to obtain data in columns from a current file to generate a periodic report, and read historic data from a historic file in the storage system;
an analyzing module operable to classify the data in the columns according to the periodic report; and
an executing module operable to set parameters of the periodic report, and generate the periodic report by executing a spreadsheet program according to the historic data, the classified column data, and the set parameters.

2. The system of claim 1, further comprising a storing module operable to store report data and the set parameters of the periodic report into the historic file.

3. The system of claim 1, wherein the set parameters comprise a color of a frame of the periodic report, sizes of frame lines, and colors of curves in the periodic report.

4. The system of claim 1, wherein the current file is a text file.

5. A computer-implemented method for generating a periodic report, the method comprising:
obtaining data in columns from a current file to generate the periodic report;
classifying the data in the columns according to the periodic report;
reading historic data from a historic file in the storage system; and
setting parameters of the periodic report, and generating the periodic report by executing a spreadsheet program according to the historic data, the classified column data, and the set parameters.

6. The method of claim 5, further comprising:
storing report data and the set parameters of the periodic report into the historic file.

7. The method of claim 5, wherein the set parameters comprise a color of a frame of the periodic report, sizes of frame lines, and colors of curves in the periodic report.

8. The method of claim 5, wherein the current file is a text file.

9. A medium having stored therein instructions that, when executed by a computer, cause the computer to perform a method for generating a periodic report comprising:
obtaining data in columns from a current file to generate the periodic report;
classifying the data in the columns according to the periodic report;
reading historic data from a historic file in the storage system; and
setting parameters of the periodic report, and generating the periodic report by executing a spreadsheet program according to the historic data, the classified column data, and the set parameters.

10. The medium of claim 9, further comprising:
storing report data and the set parameters of the periodic report into the historic file.

11. The medium of claim 9, wherein the set parameters comprise a color of a frame of the periodic report, sizes of frame lines, and colors of curves in the periodic report.

12. The medium of claim 9, wherein the current file is a text file.
